(19) United States
(12) Patent Application Publication
(10) Pub. No.: US 2022/0407052 A1
(43) Pub. Date: Dec. 22, 2022

(54) CATHODE COMPOSITION FOR LITHIUM SECONDARY BATTERY AND LITHIUM SECONDARY BATTERY FABRICATED USING THE SAME

(71) Applicant: SK ON CO., LTD., Seoul (KR)

(72) Inventors: Yong Seok LEE, Daejeon (KR); Jae Ram KIM, Daejeon (KR); Jung Hwan KIM, Daejeon (KR); Jae Yun MIN, Daejeon (KR); Sang Won BAE, Daejeon (KR); Myung Ro LEE, Daejeon (KR); Jae Yeong LEE, Daejeon (KR); Hyun Joong JANG, Daejeon (KR)

(21) Appl. No.: 17/836,445

(22) Filed: Jun. 9, 2022

(30) Foreign Application Priority Data
Jun. 11, 2021 (KR) 10-2021-0076088

(51) Int. Cl. H01M 4/36; H01M 10/0525; H01M 4/525; H01M 4/62

(52) U.S. Cl. CPC H01M 4/364; H01M 10/0525; H01M 4/525; H01M 4/625; H01M 2004/021

(57) ABSTRACT

Lithium secondary batteries for improving life span and resistance properties are disclosed. In an aspect, a cathode composition for a lithium secondary battery includes a cathode active material that includes a first cathode active material particle having a secondary particle shape and a second cathode active material particle having a single particle shape, and a conductive material including a linear-type conductive material.

### PRIORITY CLAIM AND CROSS-REFERENCE TO RELATED APPLICATION

This patent document claims the priority and benefits of Korean Patent Application No. 10-2021-0076088 filed at the Korean Intellectual Property Office (KIPO) on Jun. 11, 2021, the entire disclosure of which is incorporated herein by reference.

### TECHNICAL FIELD

This patent document generally relates to a cathode composition for a lithium secondary battery and a lithium secondary battery fabricated using the same. More particularly, this patent document relates to a cathode composition for a lithium secondary battery including a lithium metal oxide-based active material and a lithium secondary battery fabricated using the same.

### BACKGROUND

The rapid growth of electric vehicles and portable devices, such as such as camcorders, mobile phones, and laptop computers, has brought increasing demands for secondary batteries, which can be charged and discharged repeatedly.

Examples of the secondary batteries include lithium secondary batteries, nickel-cadmium batteries, and nickel-hydrogen batteries. The lithium secondary batteries are now widely used due to certain advantages over other types of batteries, including, e.g., high operational voltage and energy density per unit weight, a high charging rate, a compact dimension, etc.

A lithium secondary battery may include an electrode assembly including a cathode, an anode and a separation layer (separator), and an electrolyte immersing the electrode assembly. The lithium secondary battery may further include an outer case having, e.g., a pouch shape.

A lithium metal oxide may be used as a cathode active material of a lithium secondary battery that has high capacity, high power and enhanced life-span property. However, when the cathode active material is designed to have a high-power/capacity composition, the life-span property of the lithium secondary battery may be degraded. If the cathode active material is designed to have an enhanced life-span composition, electrical properties of the lithium secondary battery may be degraded.

For example, a cathode active material in some lithium secondary battery designs may include a transition metal compound and an ion adsorption binder. However, such a cathode active material may not provide sufficient power, capacity and life-span properties.

### SUMMARY

The technology disclosed in this patent document can be implemented in some embodiments to provide a cathode composition for a lithium secondary battery having improved stability and electrochemical properties.

The technology disclosed in this patent document can also be implemented in some embodiments to provide a lithium secondary battery having improved stability and electrochemical properties.

In some embodiments of the disclosed technology, a cathode composition for a lithium secondary battery includes a cathode active material that comprises a first cathode active material particle having a secondary particle shape and a second cathode active material particle having a single particle shape; and a conductive material including a linear-type conductive material.

In some embodiments, a weight ratio of the first cathode active material particle and the second cathode active material particle may be in a range from 9:1 to 5:5.

In some embodiments, each of the first cathode active material particle and the second cathode active material particle may be represented by Chemical Formula 1:

LiₐNiₓM₁₋ₓO_{2+y} [Chemical Formula 1]

In Chemical Formula 1, 0.9≤a≤1.2, 0.5≤x≤0.99, −0.1≤y≤0.1, and M may include at least one selected from Na, Mg, Ca, Y, Ti, Zr, Hf, V, Nb, Ta, Cr, Mo, W, Mn, Co, Fe, Cu, Ag, Zn, B, Al, Ga, C, Si, Sn, Ba and Zr.

In some embodiments, in Chemical Formula 1, 0.8≤x≤0.95.

In some embodiments, the single particle shape may include a monolithic shape in which 2 to 10 single particles are attached or adhered to each other.

In some embodiments, a peak intensity ratio of a Raman spectrum of the conductive material defined as Equation 1 may be in a range from 0.8 to 1.25:

Peak intensity ratio of Raman spectrum=I_{D}/I_{G} [Equation 1]

In Equation 1, I_{D} is a peak intensity of the conductive material in a wavenumber range of 1,335 cm⁻¹ to 1,365 cm⁻¹ in the Raman spectrum, and I_{G} is a peak intensity of the conductive material in a wavenumber range of 1,565 cm⁻¹ to 1,600 cm⁻¹.

In some embodiments, a peak intensity ratio of the Raman spectrum may be in a range from 0.8 to 1.2.

In some embodiments, the linear-type conductive material may include a carbon nanotube.

In some embodiments, the conductive material may further include a dot-type conductive material.

In some embodiments, the dot-type conductive material may include graphite, carbon black, graphene, tin, tin oxide, titanium oxide, LaSrCoO₃ or LaSrMnO₃. These materials may be used alone or in a combination thereof.

In some embodiments, a length of the linear-type conductive material may be in a range from 10 μm to 55 μm.

In some embodiments of the disclosed technology, a lithium secondary battery includes a cathode including a cathode current collector and a cathode active material layer formed by coating the cathode composition for a lithium secondary battery disclosed in this patent document on at least one surface of the cathode current collector; and an anode facing the cathode.

A cathode composition implemented based on some embodiments of the disclosed technology may include a second cathode active material particle in the form of a single particle and a linear-type conductive material. High conductivity may be obtained by the linear-type conductive material while reducing a generation of cracks by employing the single particle. Thus, life-span and power properties may be improved while suppressing an increase of resistance due to an introduction of the single particle.

In some embodiments of the disclosed technology, the cathode composition may include a first cathode active material particle in the form of a secondary particle, and a weight ratio of the first cathode active material particles relative to the second cathode active material particles may be within a predetermined range. Accordingly, the life-span properties and high temperature stability of the secondary battery may be enhanced while achieving sufficient power and capacity properties.

In some embodiments, a peak intensity ratio (I_{D}/I_{G}) of a Raman spectrum of the conductive material may be in a range from 0.8 to 1.25. In this case, cracks in the conductive material caused by an excessive crystallization may be suppressed while also preventing deterioration of crystallinity due to an excessive amorphization of the conductive material. Accordingly, resistance of the secondary battery may be reduced and high stability may be implemented.

### BRIEF DESCRIPTION OF THE DRAWINGS

FIG. 1 is an example of scanning electron microscopy (SEM) image showing a first cathode active material particle including a first structure based on some embodiments of the disclosed technology.

FIG. 2 is an example of SEM image showing a second cathode active material particle in form of a single particle in accordance with exemplary embodiments.

FIG. 3 is an example of SEM image showing a linear-type conductive material based on some embodiments of the disclosed technology.

FIG. 4 is an example of SEM image showing a dot-type conductive material based on some embodiments of the disclosed technology.

FIG. 5 is a schematic plan view of a lithium secondary battery implemented based on some embodiments of the disclosed technology.

FIG. 6 is a cross-sectional view of a lithium secondary battery implemented based on some embodiments of the disclosed technology.

### DETAILED DESCRIPTION

The technology disclosed in this patent document can be implemented in some embodiments to provide a composition for a cathode including a single particle and a linear-type conductive material, and a lithium secondary battery including a cathode that may be fabricated using the cathode composition.

Hereinafter, embodiments of the disclosed technology will be described in detail with reference to specific experimental examples and the accompanying drawings. However, those skilled in the art will appreciate that such embodiments are provided to further understand the spirit of the disclosed technology and do not limit subject matters to be protected as disclosed in the detailed description and appended claims.

In exemplary embodiments, a composition for a cathode of a lithium secondary battery (hereinafter, abbreviated as a cathode composition) may include a cathode active material including a first cathode active material particle in the form of a secondary particle and a second cathode active material particle in the form of a single particle, and a conductive material including a linear-type conductive material.

The conductive material may be included, e.g., to promote an electron movement between active material particles.

In some embodiments, the first cathode active material particle and the second cathode active material particle may be represented by Chemical Formula 1 below.

LiₐNiₓM₁₋ₓO_{2+y} [Chemical Formula 1]

In Chemical Formula 1, 0.9≤a≤1.2, 0.5≤x≤0.99, −0.1≤y≤0.1, and M may include at least one selected from Na, Mg, Ca, Y, Ti, Zr, Hf, V, Nb, Ta, Cr, Mo, W, Mn, Co, Fe, Cu, Ag, Zn, B, Al, Ga, C, Si, Sn, Ba or Zr.

In some preferable embodiments, a molar ratio or a concentration of Ni represented as x in Chemical Formula 1 may be 0.8 or more. In some implementations, the molar ratio or a concentration of Ni may exceed 0.8.

For example, in some embodiments, 0.8≤x≤0.95. In this case, properties from high capacity and high power of the lithium secondary battery may be provided.

Ni may serve as a transition metal related to the power and capacity of the lithium secondary battery. Thus, as described above, the high-Ni composition may be employed to the first cathode active material particle and the second cathode active material particle, so that a lithium secondary battery or a cathode capable of providing high power and high capacity may be achieved.

However, as a content of Ni increases, long-term storage and life-span stability of the cathode or the secondary battery may be relatively deteriorated. However, according to exemplary embodiments, life-span stability and capacity retention may be improved by including Mn while maintaining electrical conductivity by including Co.

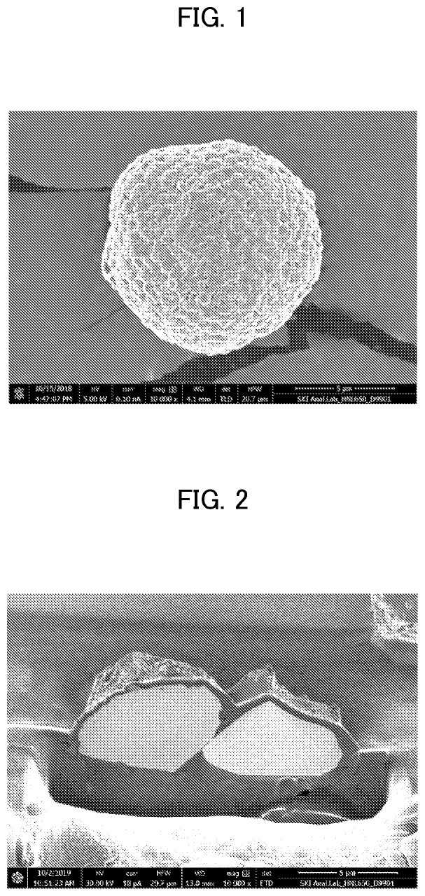

FIG. 1 is an example of scanning electron microscopy (SEM) image showing a first cathode active material particle including a first structure based on some embodiments of the disclosed technology.

Referring to FIG. 1, the first cathode active material particle may be in the form of a secondary particle (a secondary particle shape) which is formed by an agglomeration of two or more primary particles. Thus, enhanced power may be implemented from the cathode. However, micro-cracks may be easily formed inside the secondary particles during charging and discharging of the battery, and a side reaction between an electrolyte and the first cathode active material particle may be promoted to cause a gas generation inside the battery.

Accordingly, when the first cathode active material particles are solely used as a cathode active material, the life-span properties during repeated charging and discharging of the secondary battery may be deteriorated.

FIG. 2 is an example of SEM image showing a second cathode active material particle in form of a single particle in accordance with exemplary embodiments.

Referring to FIG. 2, the cathode active material may include the second cathode active material particle in form of a single particle (a single particle shape). In this case, particles may have reduced cracks, and a BET specific surface area of the particles reacting with the electrolyte may be decreased. Accordingly, the life-span properties of the secondary battery and the capacity retention during repeated charging and discharging may be improved.

In some embodiments of the disclosed technology, the term “single particle shape” may be used to indicate a particle structure that is different from a secondary particle formed by aggregation of a plurality of primary particles. For example, the second cathode active material particles may include particles of the single particle shape different from a secondary particle structure in which primary particles (e.g., the number of the primary particles in the secondary particle is greater than 10, 20 or more, 30 or more, 40 or more, 50 or more, etc.) are assembled or aggregated.

In some embodiments of the disclosed technology, the term “single particle shape” may also be used to indicate a monolithic shape in which, e.g., 2 or more particles (e.g., 2 to 10 particles) in the single particle shape are attached or adjacent to each other or integrated into a single structure.

In some embodiments, the second cathode active material particle may include a structure in which a plurality of primary particles are integrally merged together and are substantially converted into a single monolithic particle structure.

For example, the second cathode active material particle may have a granular or spherical single particle shape.

The above-described first cathode active material particles and the second cathode active material particles may be used together as a cathode active material, so that the life-span and stability of the battery at high temperature may be improved while providing enhanced power.

In some embodiments, a weight ratio of the first cathode active material particles and the second cathode active material particles included in the cathode active material may be in a range from 9:1 to 5:5. In one example, the weight ratio of the first cathode active material particles and the second cathode active material particles included in the cathode active material may be in a range from 8:2 to 7:3. In this case, the life-span and stability of the battery at high temperature may be improved while providing sufficient power and capacity of the secondary battery.

For example, the second cathode active material particle having the single particle shape may have a smaller BET specific surface area and a higher resistance than those of a cathode active material that includes the first structure or the secondary particle shape. Accordingly, electrical conductivity of the secondary battery may be slightly lowered.

In some embodiments of the disclosed technology, a conductive material included in the cathode composition may include a linear-type conductive material having improved electrical conductivity. Thus, the lowered electrical conductivity due to the introduction of the second cathode active material particle having the single particle shape may be compensated. Accordingly, a secondary battery having improved conductivity and high-temperature stability may be implemented.

In some embodiments, a peak intensity ratio in a Raman spectrum of the conductive material defined as Equation 1 below and obtained from a Raman spectroscopy analysis may be in a range from 0.8 to 1.25.

Peak intensity ratio of Raman spectrum=I_{D}/I_{G} [Equation 1]

In Equation 1, I_{D} may be a peak intensity of the conductive material in a wavenumber range of 1,335 cm⁻¹ to 1,365 cm⁻¹ in the Raman spectrum (e.g., a D band of the Raman spectrum), and I_{G} may be a peak intensity of the conductive material in a wavenumber range of 1,565 cm⁻¹ to 1,600 cm⁻¹ in the Raman spectrum (e.g., a G band of the Raman spectrum).

In some implementations, the peak intensity ratio of the Raman spectral spectrum may be in a range from 0.8 to 1.2. In one example, the peak intensity ratio of the Raman spectral spectrum may be in a range from 1.0 to 1.2. Within the above-described range of the peak intensity ratio, stability of the conductive material may be improved while having sufficient crystalline properties.

For example, the peak intensity ratio may indicate an amorphous degree of the conductive material. For example, the conductive material may have an amorphous structure as the peak intensity ratio increases, and may have a crystalline structure as the peak intensity ratio decreases.

Within the above-described range of the peak intensity ratio, some embodiments of the disclosed technology can reduce cracks in the conductive material that would have been created due to an excessive crystallization without deteriorating crystallinity due to an excessive amorphization of the conductive material. Accordingly, a resistance of the secondary battery may be reduced and enhanced stability may be achieved.

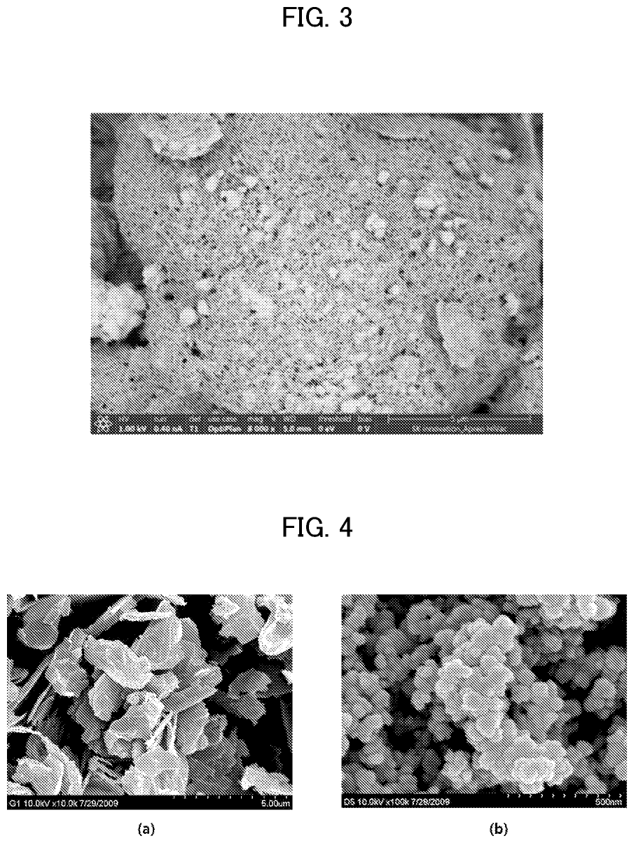

FIG. 3 is an example of SEM image showing a linear-type conductive material based on some embodiments of the disclosed technology.

In some embodiments of the disclosed technology, the term “linear-type conductive material” may be used to indicate a conductive material having an aspect ratio in a range from 2 to 20. The aspect ratio may indicate a ratio of a length relative to a diameter of the linear-type conductive material.

Referring to FIG. 3, in some embodiments, the linear-type conductive material included in the conductive material may include a carbon nanotube (CNT). For example, the linear-type conductive materials may include a single-walled CNT (SWCNT), a double-walled CNT (DWCNT), a multi-walled CNT (MWCNT), or a rope CNT. These materials may be used alone or in a combination of two or more therefrom.

The carbon nanotube may be added as the conductive material to provide the cathode having, e.g., improved electrical conductivity, and high crystallinity and stability.

In some embodiments, a length of the linear-type conductive material may be in a range from 10 μm to 55 μm. In this case, the electron movement may be facilitated between the first and second cathode active material particles without excessively increasing a distance between the particles or an electrode volume. Accordingly, the electrical conductivity of the cathode may be improved while implementing a thin battery structure.

FIG. 4 is an example of SEM image showing a dot-type conductive material based on some embodiments of the disclosed technology. For example, each of (a) portion and (b) portion of FIG. 4 is showing different dot-type conductive materials in accordance with exemplary embodiments.

The term “dot-type conductive material” used herein may refer to, e.g., a conductive material having an aspect ratio in a range from 0.5 to 1.5, and may have a substantially spherical shape. The aspect ratio may refer to a ratio of a length relative to a diameter of the dot-type conductive material.

Referring to FIG. 4, in some embodiments, the above-described conductive material may further include the dot-type conductive material. In this case, a production cost may be reduced compared to that when only using the linear-type conductive material, while maintaining the effects of using the above-described linear-type conductive material. Accordingly, a productivity of the secondary battery may also be improved.

In some implementations, a weight ratio of the linear-type conductive material and the dot-type conductive material included in the conductive material may be adjusted within a range from 1:9 to 9:1. In one example, the weight ratio of the linear-type conductive material and the dot-type conductive material included in the conductive material may be adjusted within a range from 3:7 to 7:3. Within above-described range of the weight ratio, the reduction of the production cost and an electrode resistance may both be easily lowered.

In some embodiments, the dot-type conductive material may include a carbon-based conductive material such as graphite, carbon black, graphene, carbon nanotube, etc., and/or a metal-based conductive material including, e.g., tin, tin oxide, titanium oxide, a perovskite-based material such as, LaSrCoO₃ or LaSrMnO₃, etc.

As discussed above, the disclosed technology can be implemented in some embodiments to provide a lithium secondary battery including a cathode that includes the above-described cathode composition.

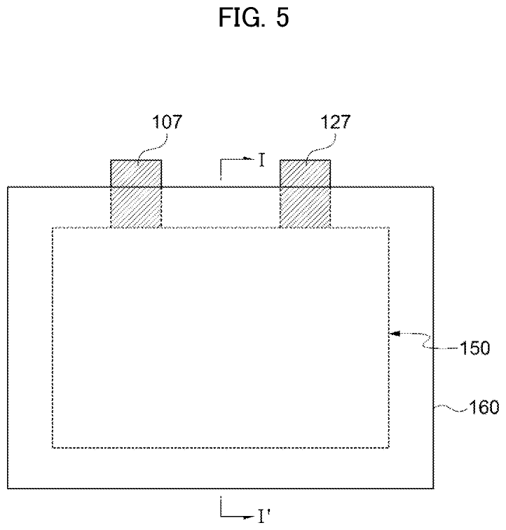

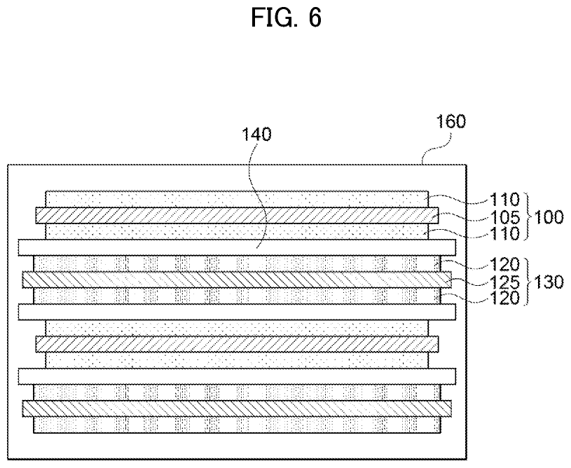

FIG. 5 is a schematic plan view of a lithium secondary battery implemented based on some embodiments of the disclosed technology. FIG. 6 is a cross-sectional view of a lithium secondary battery implemented based on some embodiments of the disclosed technology.

Referring to FIGS. 5 and 6, a lithium secondary battery may include a cathode 100, an anode 130 and a separation layer 140.

The cathode 100 may include a cathode active material layer 110 formed by coating the cathode composition that may include the first cathode active material particle, the second cathode active material particle and the conductive material on at least one surface of a cathode current collector 105.

The cathode current collector 105 may include stainless-steel, nickel, aluminum, titanium, copper or an alloy thereof. In some implementations, aluminum or an alloy thereof may be used.

For example, the cathode composition in the form of a slurry may be prepared by mixing and stirring the first cathode active material particles and the second cathode active material particles in a solvent with the conductive material including the linear-type conductive material, a binder, and a dispersive agent. The cathode composition may be coated on the cathode current collector 105, then dried and pressed to obtain the cathode 100.

The binder may include an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer 110 may be reduced, and an amount of the cathode active material may be relatively increased. Thus, capacity and power of the lithium secondary battery may be further improved.

The anode 130 may include an anode current collector 125 and an anode active material layer 120 formed by coating an anode active material on a surface of the anode current collector 125.

The anode active material may include a material that can be used to adsorb and eject lithium ions. For example, a carbon-based material such as a crystalline carbon, an amorphous carbon, a carbon complex or a carbon fiber, a lithium alloy, silicon (Si)-based compound, tin, etc., may be used.

The amorphous carbon may include a hard carbon, cokes, a mesocarbon microbead (MCMB) fired at a temperature of 1500° C. or less, a mesophase pitch-based carbon fiber (MPCF), etc. The crystalline carbon may include a graphite-based material such as natural graphite, graphitized cokes, graphitized MCMB, graphitized MPCF, etc.

The lithium alloy may further include aluminum, zinc, bismuth, cadmium, antimony, silicon, lead, tin, gallium, indium, etc.

The anode current collector 125 may include, e.g., gold, stainless steel, nickel, aluminum, titanium, copper or an alloy thereof. In some implementations, the anode current collector 125 may include copper or a copper alloy.

In some embodiments, a slurry may be prepared by mixing and stirring the anode active material with a binder, a conductive material and/or a dispersive agent in a solvent. The slurry may be coated on the anode current collector, and then dried and pressed to form the anode 130.

The binder and the conductive material substantially the same as or similar to those mentioned above may be used in the anode 130. In some embodiments, the binder for forming the anode 130 may include an aqueous binder such as styrene-butadiene rubber (SBR), and carboxymethyl cellulose (CMC) may also be used as a thickener.

The separation layer 140 may be interposed between the cathode 100 and the anode 130. The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 140 may also include a non-woven fabric formed from a glass fiber with a high melting point, a polyethylene terephthalate fiber, or the like.

In exemplary embodiments, an electrode cell may be defined by the cathode 100, the anode 130 and the separation layer 140, and a plurality of the electrode cells may be stacked to form the electrode assembly 150 that may have e.g., a jelly roll shape. For example, the electrode assembly 150 may be formed by winding, laminating or folding the separation layer 140.

The electrode assembly 150 may be accommodated together with an electrolyte in an outer case 160 to define the lithium secondary battery. In exemplary embodiments, a non-aqueous electrolyte may be used as the electrolyte.

The non-aqueous electrolyte may include a lithium salt and an organic solvent. The lithium salt may be represented by Li⁺X⁻, and an anion of the lithium salt X⁻ may include, e.g., F⁻, Cl₋, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination of two or more therefrom.

As illustrated in FIG. 5, electrode tabs (a cathode tab and an anode tab) may protrude from the cathode current collector 105 and the anode current collector 125 included in each electrode cell to one side of the outer case 160. The electrode tabs may be welded together with the one side of the case 160 to be connected to an electrode lead (a cathode lead 107 and an anode lead 127) that may be extended or exposed to an outside of the outer case 160.

The lithium secondary battery may be manufactured in, e.g., a cylindrical shape using a can, a square shape, a pouch shape or a coin shape.

Therefore, various implementations of features of the disclosed technology can be made based on the above disclosure, including the examples listed below. While the following examples contain many specifics, these should not be construed as limitations on the scope of any invention, and it should be understood that various alterations and modifications are possible based on the disclosed technology.

### Example 1

(1) Preparation of First Cathode Active Material Particle

NiSO₄, CoSO₄ and MnSO₄ were mixed in a molar ratio of 0.88:0.06:0.06, respectively using distilled water from which dissolved oxygen was removed by bubbling with N₂ for 24 hours. The solution was put into a reactor at 50° C., and NaOH and NH₃H₂O were used as a precipitating agent and a chelating agent, respectively, to proceed with a co-precipitation reaction for 72 hours to obtain Ni_{0.88}Co_{0.06}Mn_{0.06}(OH)₂ as a transition metal precursor. The obtained precursor was dried at 100° C. for 12 hours and then re-dried at 120° C. for 10 hours.

Lithium hydroxide and the transition metal precursor were added in a ratio of 1.03:1 in a dry high-speed mixer and uniformly mixed for 20 minutes. The mixture was placed in a kiln, and then a temperature was raised to 950° C. at a heating rate of 2° C./min and maintained at 950° C. for 12 hours. Oxygen was passed continuously at a flow rate of 10 mL/min during the temperature raise and maintenance. After the sintering, natural cooling was performed to room temperature, and grinding and classification were performed to prepare first cathode active material particles having a composition of LiNi_{0.88}Co_{0.06}Mn_{0.06}O₂ in the form of a secondary particle.

(2) Preparation of Second Cathode Active Material Particle

Ni_{0.83}Co_{0.13}Mn_{0.04}(OH)₂ as an NCM precursor and Li₂CO₃ and LiOH as lithium sources were mixed while being grinded for about 20 minutes. The mixed powder was sintered at a temperature of 700° C. to 1000° C. for 15 hours, and then pulverization, sieving and de-iron processes were performed to prepare second cathode active material particles having a composition of LiNi_{0.83}Co_{0.13}Mn_{0.04}O₂ in the form of a single particle (average particle diameter (D50): 5.6 μm).

(3) Fabrication of Secondary Battery

A cathode active material including the first cathode active material particles and the second cathode active material particles mixed in a weight ratio of 8:2, a linear-type conductive material (MWCNT) as a conductive material, and PVDF as a binder were mixed in a mass ratio of 94:3:3, respectively to form a cathode composition. The cathode composition was coated on an aluminum current collector, and then dried and pressed to form a cathode active material layer. Accordingly, a cathode having the cathode active material layer formed on the cathode current collector was obtained.

An average length of the MWCNTs was about 30 μm, and a BET specific surface area was 173 m²/g.

88 wt % of natural graphite as an anode active material, 5 wt % of SiOx (0<x<2), 5 wt % of KS6 as a flake type conductive material, 1 wt % of styrene-butadiene rubber (SBR) as a binder, and 1 wt % of carboxymethyl cellulose (CMC) as a thickener to prepare an anode mixture. The anode mixture was coated on a copper substrate, dried and pressed to obtain an anode.

The cathode and the anode obtained as described above were notched with a proper size and stacked, and a separator (polyethylene, thickness: 15 μm) was interposed between the cathode and the anode to form an electrode cell. Each tab portion of the cathode and the anode was welded. The welded cathode/separator/anode assembly was inserted in a pouch, and three sides of the pouch except for an electrolyte injection side were sealed. The tab portions were also included in sealed portions. An electrolyte was injected through the electrolyte injection side, and then the electrolyte injection side was also sealed. Subsequently, the above structure was impregnated for 12 hours or more.

The electrolyte was prepared by preparing 1M LiPF₆ solution in a mixed solvent of EC/EMC/DEC (25/45/30; volume ratio), and then adding 1 wt % of vinylene carbonate, 0.5 wt % of 1,3-propensultone, and 0.5 wt % of lithium bis(oxalato) borate (LiBOB).

### Examples 2 to 5

A lithium secondary battery was fabricated by the same method as that in Example 1, except that weight ratios of the first cathode active material particles and the second cathode active material particles were adjusted as shown in Table 1 below.

### Example 6

A lithium secondary battery was fabricated by the same method as that in Example 1, except that carbon black as a dot-type conductive material was further added to have a weight ratio of 1:1 with MWCNT.

### Examples 7 and 8

A lithium secondary battery was fabricated by the same method as that in Example 1, except that the average length of MWCNTs was changed as shown in Table 1 below.

### Example 9

A lithium secondary battery was fabricated by the same method as that in Example 1, except that the mass ratio of the cathode active material, MWCNT and PVDF in the cathode mixture was adjusted to 94:5:1.

### Example 10

A lithium secondary battery was fabricated by the same method as that in Example 1, except that carbon black as a dot-type conductive material was further added to have a weight ratio of 8:2 with MWCNT.

### Comparative Example 1

A lithium secondary battery was fabricated by the same method as that in Example 1, except that the first cathode active material particles were only used as the cathode active material without adding the second cathode active material particles, and carbon black was used as a conductive material instead of MWCNT.

### Comparative Example 2

A lithium secondary battery was fabricated by the same method as that in Example 1, except that carbon black was used as a conductive material instead of MWCNT.

### Experimental Example

(1) Measurement of Peak Intensity Ratio of Raman Spectrum

Raman spectrums of the conductive materials were obtained using samples from the cathode prepared by the above-described Examples and Comparative Examples and a 532 nm laser Raman Spectroscopy. In the obtained Raman spectrum, a peak intensity (I_{D}) of the conductive material in a band having a wavenumber of 1,335 cm⁻¹ to 1,365 cm⁻¹ (e.g., D band) and a peak intensity (I_{G}) of the conductive material in a band having a wavenumber of 1,565 cm⁻¹ to 1,600 cm⁻¹ (e.g., G band) were measured. The measured peak intensities were applied to Equation 1 to calculate a peak intensity ratio of the Raman spectrum.

(2) Measurement of Discharge DCIR

The lithium secondary batteries according to the above-described Examples and Comparative Examples were charged/discharged twice (SOC 100%) at 25° C., 0.5 C, and CC-CV conditions, and charged again (0.5 C, CC-CV) and then 0.5 C discharged to SOC 50%. Thereafter, a voltage was measured after standing for 30 minutes (a first voltage).

Then, a voltage (second voltage) was measured after i) 1 C discharging for 10 seconds and standing for 40 seconds, ii) 0.75 C charging for 10 seconds and standing for 40 seconds. A DCIR was measured using a difference between the first voltage and the second voltage.

(3) Measurement of Energy Density

Charging (CC-CV 0.33 C 4.2V 0.05 C SOC100 CUT-OFF) and discharging (CC 0.5 C 2.5V SOC 0 CUT-OFF) of the lithium secondary batteries according to the above-described Examples and Comparative Examples were repeated twice. An energy density (Wh/L) was measured by multiplying a discharge capacity at the second cycle by an average discharge voltage and then dividing with an area.

(4) Measurement of Cycle Capacity Retention

Charging (CC-CV 0.33 C 4.2V 0.05 C SOC96 CUT-OFF) and discharging (CC 0.5 C 2.8V SOC2 CUT-OFF) of the lithium secondary battery according to the above-described Examples and Comparative Examples were repeated 700 times in a chamber at 45° C. A capacity retention was calculated as a percentage of a discharge capacity at the 700th cycle relative to a discharge capacity at the 1st cycle.

(5) Measurement of Storage Capacity Retention

The storage capacity retention was calculated as a percentage of a discharge capacity after 20 weeks of storage in a chamber at 60° C. of the lithium secondary batteries according to the above-described Examples and Comparative Examples relative to an initial discharge capacity.

The results are shown in Tables 1 and 2 below.

TABLE 1

| | weight ratio (first | average length | Addition of | |
|---|---|---|---|---|
| | cathode active material | of linear-type | dot-type | peak intensity |
| | particle:second cathode | conductive | conductive | ratio of Raman |
| No. | active material particle) | material (μm) | material | spectrum (I_{D}/I_{G}) |
| Example 1 | 8:2 | 30 | X | 1.17 |
| Example 2 | 7:3 | 30 | X | 1.13 |
| Example 3 | 6:4 | 30 | X | 1.24 |
| Example 4 | 95:5 | 30 | X | 1.23 |
| Example 5 | 45:55 | 30 | X | 1.15 |
| Example 6 | 8:2 | 30 | ◯ | 1.06 |
| Example 7 | 8:2 | 8 | X | 1.18 |
| Example 8 | 8:2 | 60 | X | 1.13 |
| Example 9 | 8:2 | 30 | X | 1.28 |
| Example 10 | 8:2 | 30 | ◯ | 0.75 |
| Comparative | 10:0 | — | ◯ | 1.35 |
| Example 1 | | | | |
| Comparative | 8:2 | — | ◯ | 1.32 |
| Example 2 | | | | |

TABLE 2

| | | | cycle capacity | storage capacity |
|---|---|---|---|---|
| | DCIR | energy density | retention | retention |
| No. | (mΩ) | (Wh/L) | (45° C.) (%) | (60° C.) (%) |
| Example 1 | 1.34 | 719 | 86.3 | 93.2 |
| Example 2 | 1.38 | 717 | 88.0 | 93.6 |
| Example 3 | 1.41 | 716 | 89.2 | 93.8 |
| Example 4 | 1.29 | 721 | 84.5 | 92.9 |
| Example 5 | 1.51 | 708 | 90.7 | 94.2 |
| Example 6 | 1.35 | 718 | 86.8 | 93.3 |
| Example 7 | 1.39 | 718 | 85.9 | 93.0 |
| Example 8 | 1.40 | 715 | 86.2 | 93.1 |
| Example 9 | 1.41 | 717 | 86.1 | 93.2 |
| Example 10 | 1.40 | 718 | 85.9 | 92.9 |
| Comparative | 1.31 | 729 | 83.3 | 92.7 |
| Example 1 | | | | |
| Comparative | 1.40 | 719 | 86.2 | 93.1 |
| Example 2 | | | | |

Referring to Tables 1 and 2, in Examples including the second cathode active material particle having the single particle shape and the linear-type conductive material in the cathode composition, improved resistance properties were provided while maintaining or improving life-span and storage properties compared to those from Comparative Examples.

Specifically, in Example 1 where the single particle content the same as that of Comparative Example 2, a resistance was decreased while maintaining or improving capacity retentions.

In Example 4 where the content of the second cathode active material particles based on a total weight of the first cathode active material particles and the second cathode active material particles was less than 10 wt %, the capacity retentions were relatively reduced compared to those from Examples 1 to 3.

In Example 5 where the content of the second cathode active material particles based on the total weight of the first cathode active material particles and the second cathode active material particles exceeded 50 wt %, the resistance was relatively increased and the energy density was relatively decreased compared to those from Examples 1 to 3.

In Example 6 where the dot-type conductive material was added in a weight ratio of 1:1 with the linear conductive material, the resistance and life-span properties were maintained while reducing a production cost.

In Example 7 where the average length of the linear-type conductive material was less than 10 μm, and in Example 8 where the average length of the linear-type conductive material exceeded 55 μm, a distance between the cathode active material particles was not properly controlled, and the resistance became relatively greater than that from Example 1 having the same single particle content.

In Example 9 where the peak intensity ratio of the Raman spectrum exceeded 1.25, the resistance was slightly increased due to high amorphous properties.

In Example 10 where the peak intensity ratio was less than 0.8, the crystallinity was increased. Accordingly, partial particle cracks of the conductive material occurred and the resistance was slightly increased during the charging and discharging process.

Various implementations of lithium secondary batteries may be made based on the disclosed technology in this patent document. For example, a lithium secondary battery may be constructed to include a cathode, an anode and a separation layer (separator), and an electrolyte immersing the electrode assembly and the cathode is structured to include (1) a cathode active material that includes first cathode active material particles each formed by an agglomeration of two or more single particles and second cathode active material particles each formed by either a single particle or two or more single particles that are integrated with one another as a monolithic particle structure; and (2) a conductive material disposed in contact with the first and second cathode active material particles to conduct electrons and structured to include a linear-type conductive material. In this example, the agglomeration of single particles does not result in a monolithic particle structure.

For another example, a lithium secondary battery for implementing the disclosed technology may include (1) a cathode comprising a cathode current collector and a cathode active material layer formed by coating the cathode composition for the lithium secondary battery on at least one surface of the cathode current collector; and (2) an anode facing the cathode, wherein the cathode active material layer includes: a cathode active material that includes first cathode active material particles each having a non-monolithic structure that is formed by an agglomeration of two or more single particles and second cathode active material particles each formed by a single particle or by integrating two or more single particles into a single monolithic structure.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Only a few implementations and examples are described and other implementations, enhancements and variations can be made based on what is described and illustrated in this patent document.

What is claimed is:

1. A cathode composition for a lithium secondary battery, comprising:
a cathode active material that comprises a first cathode active material particle having a secondary particle shape and a second cathode active material particle having a single particle shape; and
a conductive material including a linear-type conductive material.

2. The cathode composition for a lithium secondary battery of claim 1, wherein a weight ratio of the first cathode active material particle and the second cathode active material particle is in a range from 9:1 to 5:5.

3. The cathode composition for a lithium secondary battery of claim 1, wherein each of the first cathode active material particle and the second cathode active material particle is represented by:
LiₐNiₓM₁₋ₓO_{2+y},
wherein a is greater than or equal to 0.9 and less than or equal to 1.2, x is greater than or equal to 0.5 and less than or equal to 0.99, y is greater than or equal to −0.1 and less than or equal to 0.1, and M includes at least one selected from the group consisting of Na, Mg, Ca, Y, Ti, Zr, Hf, V, Nb, Ta, Cr, Mo, W, Mn, Co, Fe, Cu, Ag, Zn, B, Al, Ga, C, Si, Sn, Ba and Zr.

4. The cathode composition for a lithium secondary battery of claim 3, wherein x is greater than or equal to 0.8 and less than or equal to 0.95.

5. The cathode composition for a lithium secondary battery of claim 1, wherein the second structure includes a monolithic structure in which two to ten single particles are attached or adhered to each other.

6. The cathode composition for a lithium secondary battery of claim 1, wherein a peak intensity ratio of a Raman spectrum of the conductive material is expressed as:
I_{D}/I_{G},
wherein the peak intensity ratio is in a range from 0.8 to 1.25,
wherein I_{D} is a peak intensity of the conductive material in a wavenumber range of 1,335 cm⁻¹ to 1,365 cm⁻¹ in the Raman spectrum, and I_{G} is a peak intensity of the conductive material in a wavenumber range of 1,565 cm⁻¹ to 1,600 cm⁻¹.

7. The cathode composition for a lithium secondary battery of claim 6, wherein the peak intensity ratio of the Raman spectrum is in a range from 0.8 to 1.2.

8. The cathode composition for a lithium secondary battery of claim 1, wherein the linear-type conductive material comprises a carbon nanotube.

9. The cathode composition for a lithium secondary battery of claim 1, wherein the conductive material further comprises a dot-type conductive material.

10. The cathode composition for a lithium secondary battery of claim 9, wherein the dot-type conductive material comprises at least one selected from the group consisting of graphite, carbon black, graphene, tin, tin oxide, titanium oxide, LaSrCoO₃ and LaSrMnO₃.

11. The cathode composition for a lithium secondary battery of claim 1, wherein a length of the linear-type conductive material is in a range from 10 μm to 55 μm.

12. A lithium secondary battery, comprising:
a cathode comprising a cathode current collector and a cathode active material layer formed by coating a cathode composition for the lithium secondary battery on at least one surface of the cathode current collector; and
an anode facing the cathode,
wherein the cathode composition for the lithium secondary battery includes:
a cathode active material that comprises a first cathode active material particle having a secondary particle shape and a second cathode active material particle having a single particle shape; and
a conductive material including a linear-type conductive material.

13. The lithium secondary battery of claim 12, wherein a weight ratio of the first cathode active material particle and the second cathode active material particle is in a range from 9:1 to 5:5.

14. The lithium secondary battery of claim 12, each of the first cathode active material particle and the second cathode active material particle is represented by:
LiₐNiₓM₁₋ₓO_{2+y},
wherein a is greater than or equal to 0.9 and less than or equal to 1.2, x is greater than or equal to 0.5 and less than or equal to 0.99, y is greater than or equal to −0.1 and less than or equal to 0.1, and M includes at least one selected from the group consisting of Na, Mg, Ca, Y, Ti, Zr, Hf, V, Nb, Ta, Cr, Mo, W, Mn, Co, Fe, Cu, Ag, Zn, B, Al, Ga, C, Si, Sn, Ba and Zr.

15. The lithium secondary battery of claim 14, wherein xis greater than or equal to 0.8 and less than or equal to 0.95.

16. The lithium secondary battery of claim 12, wherein the second structure includes a monolithic structure in which two to ten single particles are attached or adhered to each other.

17. The lithium secondary battery of claim 12, wherein a peak intensity ratio of a Raman spectrum of the conductive material is expressed as:
I_{D}/I_{G},
wherein the peak intensity ratio is in a range from 0.8 to 1.25,
wherein I_{D} is a peak intensity of the conductive material in a wavenumber range of 1,335 cm⁻¹ to 1,365 cm⁻¹ in the Raman spectrum, and I_{G} is a peak intensity of the conductive material in a wavenumber range of 1,565 cm⁻¹ to 1,600 cm⁻¹.

18. The lithium secondary battery of claim 17, wherein the peak intensity ratio of the Raman spectrum is in a range from 0.8 to 1.2.

19. The lithium secondary battery of claim 12, wherein the linear-type conductive material comprises a carbon nanotube.

20. The lithium secondary battery of claim 12, wherein the conductive material further comprises a dot-type conductive material.
